(19) United States
(12) Patent Application Publication
(10) Pub. No.: US 2001/0053705 A1
(43) Pub. Date: Dec. 20, 2001

(54) Cordless communication system for a portable computer modem

(76) Inventor: Casey J. Hull, Columbia, MO (US)

Correspondence Address: Richard C. Litman, LITMAN LAW OFFICES, LTD., P.O. Box 15035, Arlington, VA, 22215, US

(21) Appl. No.: 09/874,200

(22) Filed: Jun. 6, 2001

Related U.S. Application Data
(60) Provisional application No. 60/210,469, filed on Jun. 9, 2000.

(51) Int. Cl. H04M 1/00

(52) U.S. Cl. 455/557; 455/74.1; 455/573

(57) ABSTRACT

A communications system for cordlessly connecting a portable computer modem to a telephone line. The communications system includes a base transceiver unit and a remote transceiver unit. The base transceiver unit serves to provide a means for transmitting and receiving computer data to/from a distant computer carried over a hard-wired telephone line. The remote transceiver unit serves as a means for wirelessly transmitting and receiving computer data to/from the base transceiver unit. The base transceiver unit includes a charging bay portion, an electrical power cord, and a first antenna. The remote transceiver unit includes a second antenna and a telecommunications cable. The second antenna is communicatively connected to the remote transceiver unit for enabling the remote transceiver unit to wirelessly receive radio frequency signals. The telecommunication cable is communicatively connected to the remote transceiver unit for enabling the remote transceiver unit to communicate with a personal computer.

### CROSS-REFERENCE TO RELATED APPLICATION

This application claims the benefit of U.S. Provisional patent application Ser. No. 60/210,469, filed Jun. 9, 2000.

### BACKGROUND OF THE INVENTION

1. Field of the Invention

The present invention relates generally to the field of wireless data communication. In particular, the invention relates to a system and method for wireless access to the Internet.

2. Description of Related Art

Typically, access to what is commonly referred to as “the Internet” requires a data channel between a user terminal and an access provider. The access provider serves as a gateway for exchange of data between the user terminal and the various nodes which together comprise the Internet.

Many types of connections between the customer and an access provider are now available, each characterized by varying levels of convenience, expense and transmission efficiency. Currently, most residential users access the Internet with a conventional modem that operates at speeds of up to 28.8 kilobits per second (Kbps). Such users access an Internet service provider or an online service provider by establishing a circuit-switch connection through the public switched telephone network (PSTN). Point-to-point protocol (PPP) sessions to the Internet access point are maintained during the duration of the circuit switch connection.

Integrated Services Digital Network (ISDN) lines are increasingly being used to access the Internet with a much faster transmission speed than provided by conventional 28.8 Kbps modems. In the future, ADSL modems and cable modems are likely to offer alternative means for accessing the Internet.

Primarily due to the increased use of mobile terminals, such as “laptop” or portable computers, there is an increasing demand for access to the Internet from areas in which no wire terminal is accessible to the user. Some cellular systems attempt to meet this need by providing wireless Internet access. For example, CDPD (Cellular Digital Packet Data) is a packet data mode for analog cellular systems which provides data transmission suitable for access to the Internet. Other wireless networks, such as GSM, are also becoming available which support communication through the Internet.

While providing greater convenience in terms of user mobility, conventional wireless networks are limited in significant respects. For example, they generally are expensive relative to communication over standard telephone lines. Moreover, they are characterized by a relatively low data transmission rate (typically between 9.6 and 19.2 Kbps). Further, even yet-to-be implemented systems are relatively inefficient with respect to usage. For example, GSM will require 200 Khz spacing on both uplink and downlink, thus permitting only twenty-five frequency channels in a 10 MHz system.

U.S. Pat. No. 5,644,320 issued to Markku J. Rossi on Jul. 1, 1997 describes an antenna system for a notebook computer. The antenna system can be extended from the base section of a notebook computer to position the antenna at a predetermined remote distance from electromagnetic interference power produced by the notebook computer.

U.S. Pat. No. 5,745,884 issued to John Carnegie et al. on Apr. 28, 1998 describes a system and method for billing data grade network use on a per connection basis. A portable device is carried by a transient remote user within wireless range of an Access Point (AP) deployed at, for example, a hotel or airport lounge. A signalling resource inside the portable device automatically initiates wireless contact with AP. Wireless contact with the AP includes a data grade network address of a destination server to which the portable device desires to be connected.

U.S. Pat. No. 5,873,045 issued to Peter Lee et al. on Feb. 16, 1999 describes a mobile client computer with a radio frequency transceiver. A tripartite organization is used to facilitate adaptation of the system to alternate or later developed wireless communication technology.

U.S. Pat. No. 5,895,471 issued to Peter F. King et al. on Apr. 20, 1999 describes a system for providing a directory of frequently used hyperlinks on a remote server. Accordingly, access to hypermedia servers connected to networks, such as the Internet, can be provided through mobile devices such as wireless telephones.

U.S. Pat. No. 5,896,369 issued to Markus Warsta et al. on Apr. 20, 1999 describes a mobile communication system and method for connecting a remote workstation to a data communication network via a mobile communication network.

U.S. Pat. No. 5,905,719 issued to Hamilton Webster Arnold et al. on May 18, 1999 describes a method and system for wireless Internet access. The described technique takes into account the inherent asymmetric and busty characteristics of Internet communication to obtain more efficiency in communication between a user and an access provider.

U.S. Pat. No. 5,913,174 issued to Theresa Loney Casarez et al. on Jun. 15, 1999 describes a connectorized antenna for wireless LAN PCMCIA card radios. A removable connectorized flexible, planar antenna and a removable tethered antenna attach to a card radio for use in a wireless local network.

U.S. Pat. No. 5,937,348 issued to Michael Cina et al. on Aug. 10, 1999 describes a cordless modem comprising a radio pair interfaced to a standard data/fax modem which allows a user of a personal computer the convenience and freedom of using a PC, laptop, personal digital assistant, etc., within several hundred feet of a phone jack without being encumbered by a cord.

U.S. Pat. No. 5,963,872 issued to Per Stein on Oct. 5, 1999 describes a modular telecommunications system for an electronic audio system. The telecommunications system is configured for wireless telecommunication in accordance with a preselected standard. Modular units are adapted to be secured within AM/FM radios, tape players, automobiles, and the like, for establishing a telecommunications link with a wireless network.

European Patent No. 0,483,547 issued on May 6, 1992 describes a network address management for a wired network supporting communication to a plurality of mobile users.

However, none of the above inventions describe a cordless communication system that includes a remote transceiver unit and a base transceiver unit for enabling a enabling a user of a personal computer to wirelessly connect to a telephone line, and wherein the base transceiver unit contains a charging bay for enabling a computer user to selectively recharge the remote transceiver unit. None of the above inventions and patents, taken either singly or in combination, is seen to describe the instant invention as claimed.

### SUMMARY OF THE INVENTION

The present invention is a cordless communications system for cordlessly connecting a portable computer modem to a telephone line. The cordless communications system includes a base transceiver unit and a remote transceiver unit. The base transceiver unit serves to provide a means for transmitting and receiving computer data to/from a distant computer carried over a hard-wired telephone line. The remote transceiver unit serves as a means for wirelessly transmitting and receiving computer data to/from the base transceiver unit.

The base transceiver unit includes a charging bay portion, an electrical power cord, and a first antenna. The charging bay portion consists of a cavity formed in the base transceiver unit for receiving and charging the remote transceiver. The electrical power cord is electrically connected to the base transceiver unit for enabling AC power to be supplied to the base transceiver unit. The first antenna is communicatively connected to the base transceiver unit for enabling the base transceiver unit to wirelessly receive radio frequency signals from the remote transceiver unit.

The remote transceiver unit includes a second antenna and a telecommunications cable. The second antenna is communicatively connected to the remote transceiver unit for enabling the remote transceiver unit to wirelessly receive radio frequency signals. The telecommunication cable is communicatively connected to the remote transceiver unit for enabling the remote transceiver unit to communicate with a personal computer.

Accordingly, it is a principal object of the invention to a cordless communication system capable of recharging a remote transceiver unit.

It is another object of the invention to provide a cordless communication system for enabling a user of a personal computer to wirelessly connect to a telephone line via a standard modular wall jack.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a cordless communication system according to the present invention.

FIG. 2 is a perspective view of a base transceiver unit according to present invention.

FIG. 3 is a perspective view of a remote transceiver unit according to the present invention.

Similar reference characters denote corresponding features consistently throughout the attached drawings.

### DETAILED DESCRIPTION OF THE PREFERRED EMBODIMENTS

The present invention is a cordless communication system for enabling a user of a personal computer to wirelessly connect to a telephone line via a standard modular wall jack. The present invention is also designed for enabling the user to recharge a remote transceiver unit.

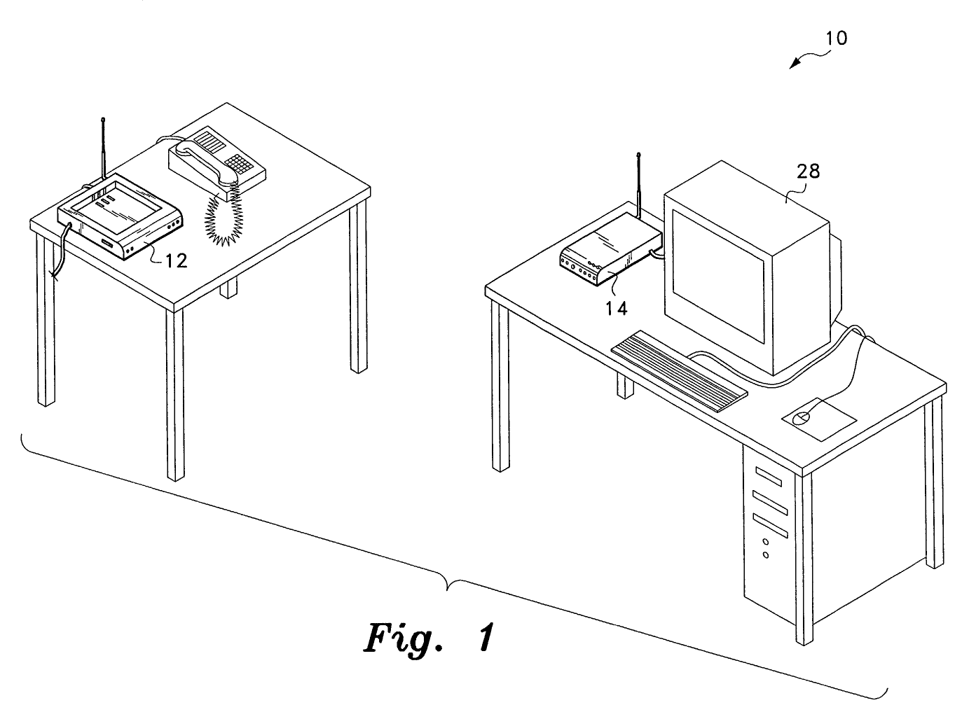

An environmental view of a cordless communication system 10 according to a preferred embodiment of the invention is shown in FIG. 1. The cordless communication system 10 includes a base transceiver unit 12 and a remote transceiver unit 14.

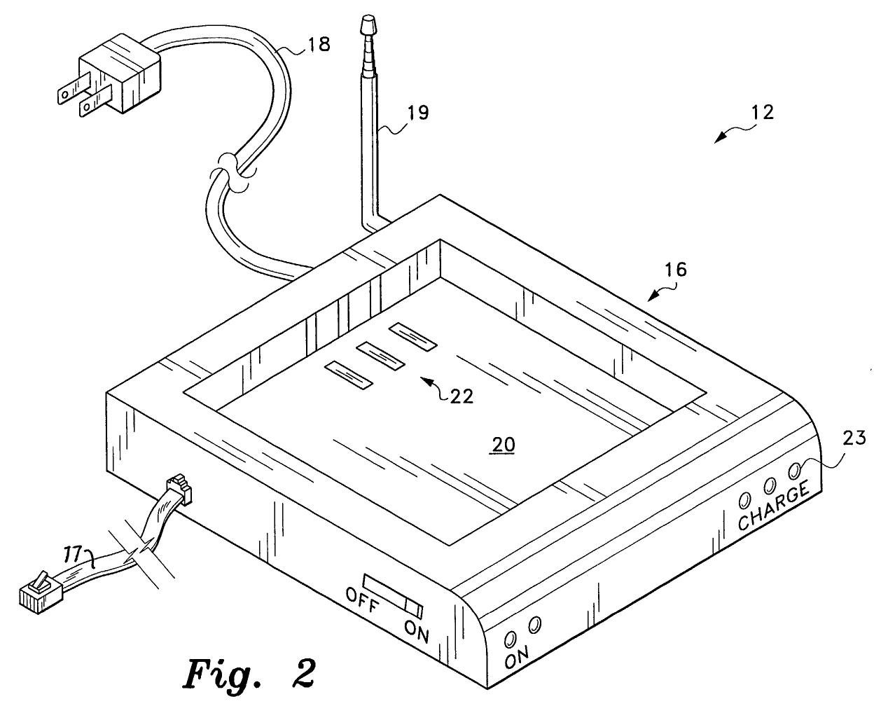

Referring to FIG. 2, the base transceiver unit 12 is designed to include a charging bay 16, an electrical power cord 18, and a first antenna 19. The charging bay 16 serves to enable the base transceiver unit 12 to recharge the remote transceiver unit 14 by means of a battery charging circuit housed in the base transceiver unit. The charging bay 16 consists of a cavity 20 formed in the base transceiver unit. The cavity 20 is configured in a shape that marginally exceeds but substantially matches the shape of the remote transceiver unit 14 for enabling the remote transceiver unit 14 to be received in the cavity 20 for recharging the remote transceiver unit 14. The charging bay 16 may be designed to include a plurality of contacts 22 or equivalent electrical means at the bottom of the cavity 20 for enabling the base transceiver unit 12 to charge the remote transceiver unit 14 when the remote transceiver unit 14 is fitted inside the cavity 20.

The power cord 18 is a conventional electrical power cord electrically connected to the base transceiver unit 12 for enabling the base transceiver unit 12 to be powered from the AC mains by a conventional AC power outlet.

The first antenna 19 is communicatively connected by conventional means to the base transceiver unit 12 for enabling the base transceiver unit 12 to wirelessly receive radio frequency signals from the remote transceiver unit. The first antenna 19 preferably has a conventional telescoping design for enabling the first antenna 19 to be selectively extended to improve reception of radio frequency signals.

The base transceiver unit 12 may be designed to include a plurality of first “charge” lights 23 for indicating when the base transceiver unit 12 is operating in a charge mode to recharge the remote transceiver unit 14. The base transceiver unit 12 is designed to include conventional circuit means for enabling the first “charge” lights 23 to light up whenever the base transceiver unit 12 operates in a recharge mode to recharge the remote transceiver unit 14.

The base transceiver unit 12 includes a first telecommunications cable 17 for connecting the base transceiver unit 12 to a telephone line by a conventional phone jack. The base transmitter unit 12 houses a conventional telephone modem which is connected to the telephone line by cable 17 and which is also connected to the radio transceiver in the base unit 12 so that data received by the base unit 12 from the remote transceiver 14 can be retransmitted over the telephone line, and so that data received from the telephone line may be retransmitted from the base transceiver unit 12 to the remote transceiver unit 14.

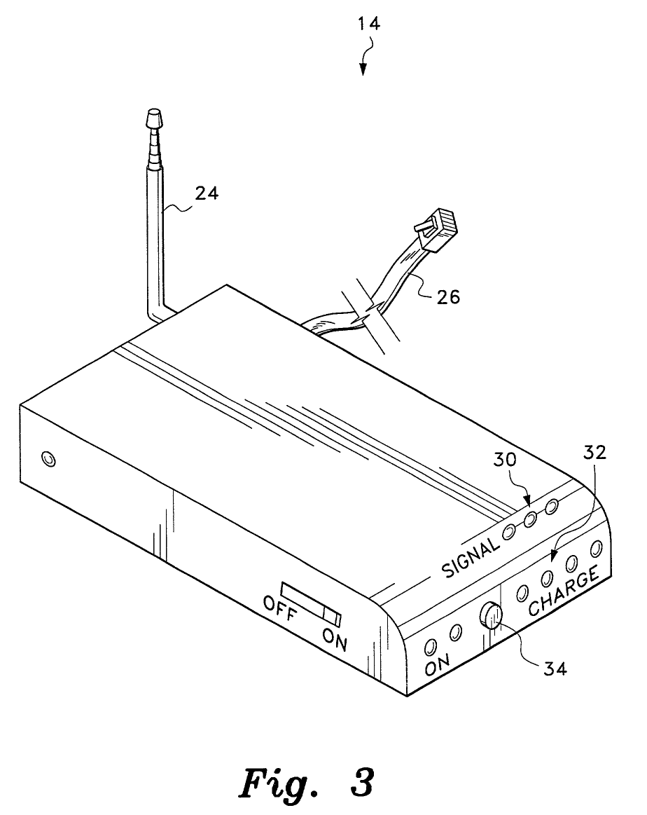

Referring to FIG. 3, the remote transceiver unit 14 houses a radio transceiver powered by rechargeable batteries and is designed to include a second antenna 24 and a second telecommunications cable 26. The second antenna 24 is a conventional aerial antenna for receiving radio frequency signals. The second antenna 24 is communicatively connected to the remote transceiver unit 14 for enabling the remote transceiver unit 14 to wirelessly receive radio frequency signals from the base transceiver unit 12. The second antenna 24 may have a telescoping configuration for enabling the second antenna 24 to be selectively extended to improve reception of radio frequency signals.

The second telecommunications cable 26 is a conventional telephone cable for telecommunications. The second telecommunications cable 26 is communicatively connected between the remote transceiver unit 14 and a personal computer 28 for enabling the remote transceiver unit 14 to communicate with the computer 28. The remote transceiver unit 14 may contain a plurality of “signal” lights 30 for indicating when the remote transceiver unit 14 is receiving a radio frequency signal. The remote transceiver unit 14 is designed to include conventional circuit means for enabling the “signal” lights 30 to be turned on whenever the remote transceiver unit 14 is receiving a radio frequency signal.

The remote transceiver unit 14 may also be configured to include a plurality of second “charge” lights 32 for indicating when the remote transceiver unit is being recharged. The remote transceiver unit 14 may be designed to include additional conventional circuit means for enabling the second “charge” lights 32 to be turned on whenever the remote transceiver unit is being recharged. The remote transceiver unit may also include a dial-up connection button 34, which wirelessly connects the remote transceiver and the base transceiver. When the button 34 is activated, it starts the reception of the necessary data and the dialing so that the modem can establish a connection.

It is to be understood that the present invention is not limited to the sole embodiments described above, but encompasses any and all embodiments within the scope of the following claims.

I claim:

1. A cordless communications system for cordlessly connecting a portable computer modem to a telephone line, comprising:
a base transceiver unit for transmitting and receiving computer data to/from a distant computer carried over a hard-wired telephone line, said base transceiver unit further having:
a charging bay portion for enabling said base transceiver unit to recharge said remote transceiver;
an electrical power cord electrically connected to said base transceiver unit;
a first antenna communicatively connected to said base transceiver unit for enabling said base transceiver unit to be powered by a conventional AC power outlet; and
a first telecommunications cable for connecting said base transceiver unit to a telephone line;
a remote transceiver unit for wirelessly transmitting and receiving computer data to/from said base transceiver, said remote transceiver unit being powered by at least one rechargeable battery, said remote transceiver further having:
a second antenna communicatively connected to said remote transceiver unit for enabling said remote transceiver unit to wirelessly receive radio frequency signals; and
a second communications cable communicatively connected to said remote transceiver unit for enabling said remote transceiver unit to communicate with a personal computer.

2. The cordless communications system recited in claim 1, wherein said charging bay portion includes a cavity formed in said base transceiver unit, said cavity being configured in a shape that is substantially identical to said remote transceiver unit, said cavity being sized marginally greater than said remote transceiver unit for enabling said remote transceiver unit to fit inside of said cavity.

3. The cordless communications system recited in claim 1, wherein said first antenna has a telescoping design for enabling said first antenna to be selectively extended to improve reception of radio frequency signals.

4. The cordless communications system recited in claim 1, wherein said second antenna has a telescoping design for enabling said second antenna to be selectively extended to improve reception of radio frequency signals.

5. The cordless communications system recited in claim 1, wherein said base transceiver unit further includes a plurality of charge lights for indicating when said base transceiver unit is operating in a charge mode to recharge said remote transceiver unit.

6. The cordless communications system recited in claim 1, wherein said remote transceiver unit further includes a plurality of signal lights for indicating when said remote transceiver unit is receiving a radio frequency signal.

7. The cordless communications system recited in claim 1, wherein said remote transceiver unit further includes a plurality of second charge lights for indicating when said remote transceiver unit is being recharged.

8. The cordless communications system recited in claim 1, wherein said remote transceiver unit further includes a dial-up connection button which a user can activate to instruct the modem to establish a connection.
